(19) United States
(12) Patent Application Publication
(10) Pub. No.: US 2024/0410716 A1
(43) Pub. Date: Dec. 12, 2024

(54) MEASUREMENT APPARATUS, METHOD OF ACTIVATING MEASUREMENT APPARATUS, AND NON-TRANSITORY COMPUTER READABLE MEDIUM

(71) Applicants: Yokogawa Electric Corporation, Tokyo (JP); Yokogawa Test & Measurement Corporation, Tokyo (JP)

(72) Inventors: Yuta Ohashi, Tokyo (JP); Kouichi Kataoka, Tokyo (JP)

(73) Assignees: Yokogawa Electric Corporation, Tokyo (JP); Yokogawa Test & Measurement Corporation, Tokyo (JP)

(21) Appl. No.: 18/671,273

(22) Filed: May 22, 2024

(30) Foreign Application Priority Data
Jun. 12, 2023 (JP) 2023-096575

(51) Int. Cl. G01D 3/036

(52) U.S. Cl. CPC G01D 3/036

(57) ABSTRACT

A measurement apparatus includes a management unit, a timer, an activation processing unit, and a module. The management unit is configured to set a timer activation time to the timer. The timer is configured to output an activation signal to the activation processing unit upon reaching the timer activation time. The activation processing unit is configured to start to activate the module upon an input of the activation signal.

### CROSS-REFERENCE TO RELATED APPLICATION

This application claims priority to Japanese Patent Application No. 2023-96575, filed on Jun. 12, 2023, the entire contents of which are incorporated herein by reference.

### TECHNICAL FIELD

The present disclosure relates to a measurement apparatus, a method of activating a measurement apparatus, and a non-transitory computer readable medium.

### BACKGROUND

Conventionally, as described in Patent Literature (PTL) 1, measurement instruments that display a remaining warm-up time required to obtain a certain measurement accuracy are known.

### CITATION LIST

### Patent Literature

PTL 1: JP 2007-147292 A

### SUMMARY

A measurement apparatus according to some embodiments includes a management unit, a timer, an activation processing unit, and a module. The management unit is configured to set a timer activation time to the timer. The timer is configured to output an activation signal to the activation processing unit upon reaching the timer activation time. The activation processing unit is configured to start to activate the module upon an input of the activation signal.

A method of activating a measurement apparatus according to some embodiments is performed by a measurement apparatus including a management unit, a timer, an activation processing unit, and a module. The method includes setting, by the management unit, a timer activation time to the timer. The method includes outputting, by the timer, an activation signal upon reaching the timer activation time. The method includes starting, by the activation processing unit, to activate the module upon an input of the activation signal.

A non-transitory computer readable medium according to some embodiments stores an activation program for a measurement apparatus. The activation program for the measurement apparatus is configured to cause a measurement apparatus, which includes a module, a management unit, a timer configured to output an activation signal upon reaching a timer activation time, and an activation processing unit configured to start to activate the module upon an input of the activation signal, to execute an operation. The operation includes setting, by the management unit, the timer activation time to the timer.

### BRIEF DESCRIPTION OF THE DRAWINGS

In the accompanying drawings:

FIG. 1 is a block diagram of a measurement apparatus according to a comparative example;

FIG. 2 is a block diagram illustrating an example of the configuration of a measurement apparatus according to an embodiment;

FIG. 3 is a diagram illustrating an example of state transitions of the measurement apparatus;

FIG. 4 is a flowchart illustrating an example of a procedure for setting a timer of the measurement apparatus;

FIG. 5 is a flowchart illustrating an example of a procedure for activating the measurement apparatus; and

FIG. 6 is a block diagram illustrating an example of the configuration of a measurement apparatus according to another embodiment.

### DETAILED DESCRIPTION

Users of measurement apparatuses have to wait until warm-ups are completed after activating the measurement apparatuses. The occurrence of waiting times is detrimental to the users' convenience. The present disclosure provides a measurement apparatus, a method of activating a measurement apparatus, and a non-transitory computer readable medium that enhance the convenience of a user of the measurement apparatus.
(1) A measurement apparatus according to some embodiments includes a management unit, a timer, an activation processing unit, and a module. The management unit is configured to set a timer activation time to the timer. The timer is configured to output an activation signal to the activation processing unit upon reaching the timer activation time. The activation processing unit is configured to start to activate the module upon an input of the activation signal. Since the measurement apparatus automatically starts to be activated, a user does not have to come to an installation location of the measurement apparatus during at least part of a period from when the measurement apparatus starts being activated until when the measurement apparatus is put into a usable state. As a result, the user can make effective use of time. In addition, the user's convenience is improved.
(2) In the measurement apparatus described in (1) above according to one embodiment, the management unit may be configured to acquire a use start time at which the user starts to use the measurement apparatus, and a warm-up time for an attached module that is the module detachably attached to the measurement apparatus, and set, to the timer, a time at which at least the warm-up time is subtracted from the use start time, as the timer activation time. Since the timer activation time is set based on the warm-up time, the activation can be started according to the time at which the user desires to start to use the measurement apparatus. As a result, the user's waiting time is reduced. In addition, the time from when the measurement apparatus is put into the usable state until when the user starts to use the measurement apparatus is shortened. In other words, the time that the measurement apparatus is not used by the user even though the measurement apparatus is in the usable state is shortened. As a result, the power consumption of the measurement apparatus is reduced.
(3) In the measurement apparatus described in (2) above according to one embodiment, in a case in which a plurality of modules is attached as attached modules, the management unit may set, to the timer, a time at which at least the longest warm-up time, among warm-up times for the plurality of respective attached modules, is subtracted from the use start time, as the timer activation time. Since the timer activation time is set based on the longest warm-up time, among the warm-up times of the plurality of respective attached modules, the user does not have to know the warm-up time of each of the plurality of attached modules. As a result, the user's convenience is improved.
(4) In the measurement apparatus described in (3) above according to one embodiment, the activation processing unit may be configured to start to activate only some of the plurality of attached modules. Since only some of the attached modules can be automatically activated, unnecessary modules are not activated. Not activating the unnecessary modules reduces the power consumption of the measurement apparatus.
(5) In the measurement apparatus described in any one of (2) to (4) above according to one embodiment, the management unit may be configured to calculate the warm-up time for the attached module based on an installation environment of the measurement apparatus. Since the warm-up time is calculated based on the installation environment, the user does not have to know trends in variation of the warm-up time for the attached module or predict the warm-up time. As a result, the user's convenience is improved.
(6) In the measurement apparatus described in any one of (2) to (5) above according to one embodiment, the management unit may be configured to calculate the warm-up time for the attached module based on a track record of a past warm-up time for the attached module. Since the warm-up time is calculated based on the track record of the past warm-up time, the user does not have to know trends in variation of the warm-up time for the attached module or predict the warm-up time. As a result, the user's convenience is improved.
(7) In the measurement apparatus described in any one of (1) to (6) above according to one embodiment, the management unit may be configured to set, to the timer, a time determined from a predetermined schedule, as the timer activation time. Since the time determined from the predetermined schedule is set as the timer activation time to the timer, an omission of setting the timer activation time or the use start time is reduced. In addition, the user's operation to set the timer activation time or the use start time is omitted. As a result, the user's convenience is improved.
(8) In the measurement apparatus described in any one of (1) to (7) above according to one embodiment, the activation processing unit may be configured to comprise a terminal connectable to an external apparatus, and output, from the terminal, a signal to activate the external apparatus upon the input of the activation signal. Since the measurement apparatus can activate the external apparatus, the user can use the external apparatus as if the external apparatus were provided with a timer, even when the external apparatus is not provided with a timer. As a result, the user's convenience is improved.
(9) A method of activating a measurement apparatus according to some embodiments is performed by a measurement apparatus including a management unit, a timer, an activation processing unit, and a module. The method includes setting, by the management unit, a timer activation time to the timer. The method includes outputting, by the timer, an activation signal upon reaching the timer activation time. The method includes starting, by the activation processing unit, to activate the module upon an input of the activation signal.
(10) A non-transitory computer readable medium according to some embodiments stores an activation program for a measurement apparatus. The activation program for the measurement apparatus is performed by a measurement apparatus including a module, a management unit, a timer configured to output an activation signal upon reaching a timer activation time, and an activation processing unit configured to start to activate the module upon an input of the activation signal. The activation program is configured to cause the measurement apparatus to execute an operation including setting, by the management unit, the timer activation time to the timer.

The measurement apparatus, the method of activating a measurement apparatus, and the non-transitory computer readable medium according to the present disclosure improve the convenience of the user of the measurement apparatus.

Apparatuses may be used to measure objects to be measured. Unless the apparatuses are not in constant operation, the apparatuses are stopped while not measuring. Therefore, the apparatuses are activated for the measurement. The apparatuses have to be warmed up to enhance measurement accuracy. After the apparatuses have been activated and warmed up, the measurement can start. In cases in which the apparatuses are configured with insertable and detachable modules used for the measurement, warm-up times of the apparatuses may vary depending on the attached modules. This makes it difficult to know timing at which the apparatuses have been activated and the measurement can be started.

An embodiment of the present disclosure will be described below, compared with a comparative example.

### Comparative Example

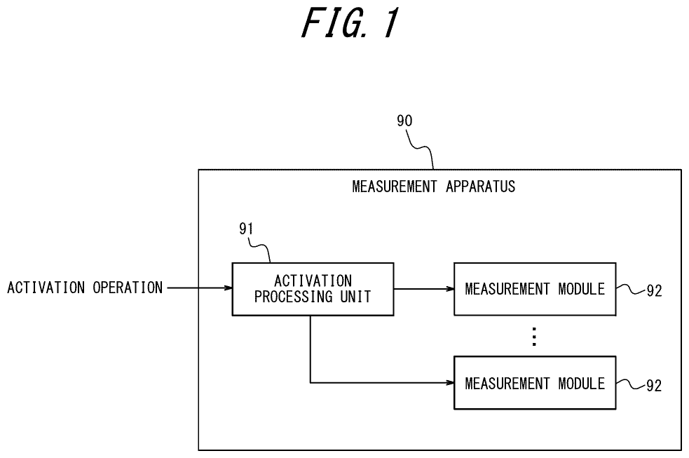

As illustrated in FIG. 1, a measurement apparatus 90 according to the comparative example is provided with an activation processing unit 91 and a plurality of measurement modules 92. The activation processing unit 91 starts to activate each of the measurement modules 92 upon accepting an activation operation from a user of the measurement apparatus 90. Each measurement module 92 starts to be activated and performs a warm-up. The time required for the warm-up is also referred to as a warm-up time. The warm-up is completed when the warm-up time has elapsed from the start of activation. Completing the warm-up enables each measurement module 92 to perform measurement with predetermined accuracy. After the warm-ups of the measurement modules 92 are completed, the user of the measurement apparatus 90 measures an object to be measured using the measurement modules 92.

The state in which the measurement apparatus 90 is not being activated is also referred to as a sleep state or a stop state. The state in which the measurement apparatus 90 performs a warm-up when being activated is also referred to as a warm-up state. The state in which the measurement apparatus 90 has completed the warm-up and becomes usable is also referred to as a usable state. Upon accepting a stop operation from the user, the measurement apparatus 90 shuts down and stops each of the measurement modules 92, and returns to the sleep state.

The user of the measurement apparatus 90 according to the comparative example has to wait until the warm-up of the measurement apparatus 90 is completed, in order to perform measurement using the measurement apparatus 90. To start measurement at a predetermined time, the user performs the following procedure.
(1) The user checks a warm-up time for a measurement module 92 to be used for the measurement. When multiple measurement modules 92 are used for the measurement, the user checks a warm-up time for each of the multiple measurement modules 92 and checks the longest warm-up time.
(2) The user inputs an activation operation to the activation processing unit 91 at the time the warm-up time for the measurement module 92 before the time at which the measurement is to be started, or at the time the longest warm-up time, among the warm-up times for the multiple measurement modules 92, before the time at which the measurement is to be started.
(3) The user waits for the measurement apparatus 90 to perform the warm-up and be put into the usable state, and then starts the measurement using the measurement apparatus 90.

As described above, the user of the measurement apparatus 90 according to the comparative example has to check the warm-up time of each measurement module 92 and input the activation operation to the measurement apparatus 90 at a time at least the warm-up time before the time at which the measurement is to be started. When the measurement module 92 is insertable into and detachable from the measurement apparatus 90, the user also has to check which measurement module 92 is attached to the measurement apparatus 90. In other words, it takes time for the user to do operation before starting the measurement. The time-consuming operation before starting the measurement reduces the user's convenience.

Therefore, in order to improve the user's convenience, it is required to eliminate the need for the user's operation to check the warm-up time or wait until the warm-up time elapses.

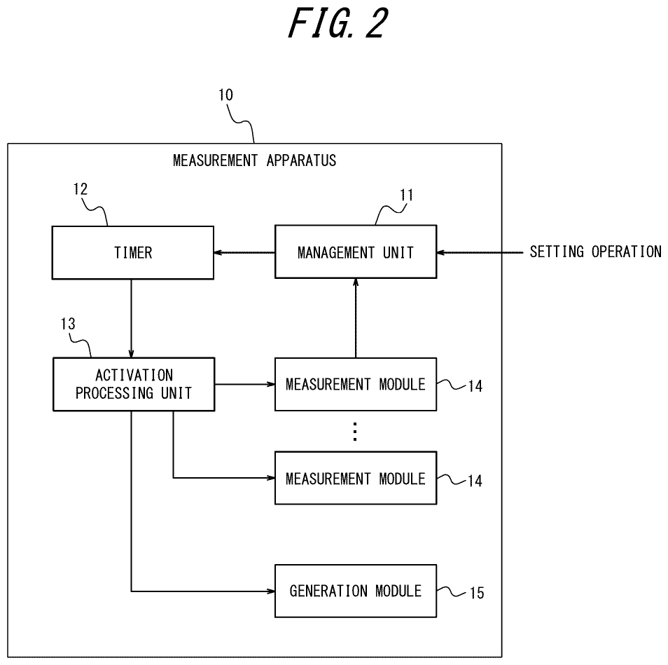

A measurement apparatus 10 (see FIG. 2) that can improve the user's convenience will be described below.

### Example of Configuration of Measurement Apparatus 10

As illustrated in FIG. 2, the measurement apparatus 10 according to an embodiment of the present disclosure includes a management unit 11, a timer 12, an activation processing unit 13, measurement modules 14, and a generation module 15. The measurement modules 14 and the generation module 15 are also collectively referred to simply as modules. Hereafter, when there is no need to distinguish between the measurement module 14 and the generation module 15 in the present disclosure, the measurement module 14 or the generation module 15 is simply described as a module. The measurement apparatus 10 is configured to start to activate the module upon reaching a time set to the timer 12.

### <Module>

The module is attached to the measurement apparatus 10. The module may be configured to be detachable from the measurement apparatus 10. The module may be attached to or detached from the measurement apparatus 10. The module that is attached to the measurement apparatus 10 is also referred to as an attached module. The attached module may be attached detachably from the measurement apparatus 10.

The measurement apparatus 10 may include only the measurement modules 14 without the generation module 15. The measurement apparatus 10 may include only the generation module 15 without the measurement modules 14. The measurement apparatus 10 may include only one module or multiple modules.

The module requires a predetermined warm-up time from activation to complete a warm-up. The warm-up time of the module may differ from module to module according to difference in the type, model number, or the like of the module. The warm-up time of the module may vary depending on an environment, such as temperature or humidity at the time of activating the module. The module may be configured to output its own warm-up time in response to an external inquiry for the warm-up time. The module may be configured to be able to output information to identify the type, model number, or the like of the module itself in response to an external inquiry.

The measurement module 14 may include sensors that can measure various physical quantities, such as, for example, the intensity or wavelength of light emitted from an object to be measured, a current flowing through the object to be measured, a voltage applied to the object to be measured, or the temperature of the object to be measured.

The generation module 15 may include, for example, a light source module that applies light to the object to be measured, a voltage source module that applies a voltage to the object to be measured, or a current source module that flows a current into the object to be measured.

### <Management Unit 11>

The management unit 11 sets a time to the timer 12, based on the warm-up time of the module and a time at which a user starts measurement. The management unit 11 may be configured with a processor, such as a central processing unit (CPU). The management unit 11 may realize predetermined functions by having the processor execute a predetermined program. The management unit 11 may be configured with a dedicated circuit, such as a field programmable gate array (FPGA), for example.

The management unit 11 may be provided with a memory. The memory may store various types of information to be used in operations of the management unit 11, the program to realize the functions of the management unit 11, and the like. The memory may function as a work memory of the management unit 11. The memory may be composed of, for example, a semiconductor memory or the like. The memory may include a volatile memory or a non-volatile memory. The memory may be included in the management unit 11 or may be configured separately from the management unit 11.

The management unit 11 may be provided with a communication device for communicably connected with a wire or wirelessly to the timer 12 or the module. The communication device may be provided with a communication interface such as a local area network (LAN), RS-232C or RS-485, or the like, for example. The communication device is not limited to these, but may include a variety of other communication interfaces.

The management unit 11 may be provided with an input device that accepts an input from the user. The input device may include, for example, a keyboard or a physical key, or a pointing device such as a touch panel or a touch sensor or a mouse.

The management unit 11 may be provided with a display device for displaying settings and other information. The display device may include a variety of displays, such as liquid crystal displays, for example.

### <Timer 12>

The timer 12 outputs an activation signal to the activation processing unit 13 upon reaching the set time. The timer 12 operates even while the measurement apparatus 10 is shut down. The timer 12 may be configured as an electronic device. While the measurement apparatus 10 is shut down, the timer 12 may be operated by power supplied from a backup battery or by power supplied from a power supply of the measurement apparatus 10. The timer 12 may be configured to operate mechanically.

### <Activation Processing Unit 13>

When the measurement apparatus 10 is in a shutdown state, the activation processing unit 13 activates the activation processing unit 13 itself upon an input of the activation signal from the timer 12. The activation processing unit 13 may activate the activation processing unit 13 itself not only upon the input of the activation signal from the timer 12, but also upon an input of the activation signal by the user's operation, including, for example, the user pressing a power button. The activation processing unit 13 also activates the system of the measurement apparatus 10, including the management unit 11 and the like. The activation processing unit 13 activates the attached module after activating the activation processing unit 13 itself. When multiple modules are attached to the measurement apparatus 10, the activation processing unit 13 activates each of the multiple attached modules.

The activation signal may be an electrical signal, such as a current signal or a voltage signal. The activation signal may be input in the form of pressing a mechanical activation switch, such as a physical key or a physical button. The activation signal may be a signal that reproduces the electrical signal produced when the mechanical activation switch is pressed. The activation signal may be input in various forms, not limited to these examples. In the measurement apparatus 10 according to the present disclosure, the activation signal is assumed to be input as the electrical signal.

The activation processing unit 13 may be configured as an electronic circuit. The activation processing unit 13 may be configured with a processor, such as a CPU, or a dedicated circuit, such as an FPGA.

### Example of Operations of Measurement Apparatus 10

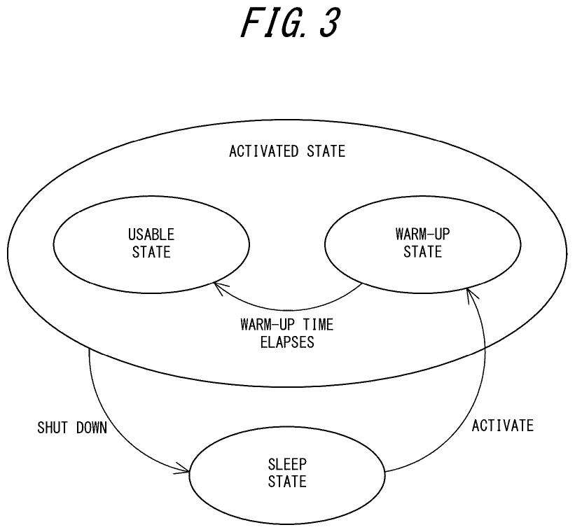

The measurement apparatus 10 transitions to multiple states as illustrated in FIG. 3. The state in which the measurement apparatus 10 is not activated is also referred to as the sleep state or the stop state. The measurement apparatus 10 starts to be activated and performs a warm-up. The state in which the measurement apparatus 10 performs the warm-up is also referred to as the warm-up state. The warm-up of the measurement apparatus 10 is completed when the warm-up time has elapsed. Completing the warm-up of the measurement apparatus 10 makes the measurement apparatus 10 usable. The state in which the measurement apparatus 10 is made usable is also referred to as the usable state. The state in which the measurement apparatus 10 is in the warm-up or the usable state is also collectively referred to as an activated state. When the measurement apparatus 10 is in the activated state, upon accepting a stop operation from the user, the measurement apparatus 10 shuts down and stops the module and returns to the sleep state.

The measurement apparatus 10 according to the present disclosure automatically starts to be activated, using the timer 12, by timer activation without the user having to input an activation operation. Operations of the measurement apparatus 10 starting to be activated by the timer activation will be described below.

### <Setting of Timer Activation Time>

In the activated state of the measurement apparatus 10, the management unit 11 of the measurement apparatus 10 sets a time to have the timer 12 output the activation signal. The time to have the timer 12 output the activation signal is also referred to as a timer activation time. The management unit 11 may set the timer activation time with or without considering the warm-up time for the module.

### <<In the Case of Considering Warm-up Time>>

The user sets a time at which the user starts to use the measurement apparatus 10. The time at which the user starts to use the measurement apparatus 10 is also referred to as a use start time. The management unit 11 acquires the setting of the use start time. The management unit 11 may accept, by the input device, an input of the user setting the use start time.

The management unit 11 acquires the warm-up time of the attached module that is attached to the measurement apparatus 10. The management unit 11 may acquire the warm-up time by communicating with the attached module. The management unit 11 may acquire the warm-up time of the module when the module is attached to the measurement apparatus 10 and store the warm-up time in the memory, and may acquire the warm-up time of the attached module from the memory.

The management unit 11 may identify the attached module and acquire the warm-up time of the identified attached module from a table, a database, or the like that identifies the relationship between the module and the warm-up time. The table, the database, or the like that identifies the relationship between the module and the warm-up time may be prepared in advance by the manufacturer or the distributor of the module. The management unit 11 may store the table, the database, or the like that identifies the relationship between the module and the warm-up time in the memory in advance.

The management unit 11 may identify the attached module by acquiring an identifier, such as the type or the model number of the attached module. The management unit 11 may acquire the identifier of the attached module by communicating with the attached module. The management unit 11 may acquire the identifier of the attached module by an input of the user.

The management unit 11 may acquire only the warm-up time for the attached module, without identifying the attached module.

The management unit 11 calculates the timer activation time based on the use start time and the warm-up time. Specifically, the management unit 11 calculates, as the timer activation time, a time at which at least the warm-up time for the attached module is subtracted from the use start time set by the user. When only the warm-up time is subtracted from the use start time, the management unit 11 calculates, as the timer activation time, the time the warm-up time before the use start time.

When multiple modules are attached to the measurement apparatus 10, the management unit 11 determines the longest warm-up time, among warm-up times for the multiple attached modules. The management unit 11 calculates, as the timer activation time, a time at which at least the longest warm-up time is subtracted from the use start time. When only the longest warm-up time is subtracted from the use start time, the management unit 11 calculates, as the timer activation time, the time the longest warm-up time before the use start time.

As described above, when the measurement apparatus 10 is in the shutdown state, the activation processing unit 13 activates the activation processing unit 13 itself upon the input of the activation signal from the timer 12. A time required for the activation processing unit 13 to activate the activation processing unit 13 itself is also referred to as an activation time. The management unit 11 may set the timer activation time by further considering the activation time. For example, the management unit 11 may calculate, as the timer activation time, the time at which the activation time is further subtracted from the time at which the warm-up time is subtracted from the use start time.

The management unit 11 sets the calculated timer activation time to the timer 12.

### <<In the Case of Not Considering Warm-up Time>>

The user sets the timer activation time. The management unit 11 acquires the setting of the timer activation time. The management unit 11 may accept, by the input device, an input of the user setting the timer activation time. The management unit 11 sets, to the timer 12, the timer activation time set by the user.

Even in the case of not considering the warm-up time, the management unit 11 may set the timer activation time to the timer 12 in consideration of the activation time. For example, the management unit 11 may calculate the time of subtracting the activation time from the timer activation time set by the user, and set the calculated time to the timer 12.

### <Activation by Timer 12>

The user may shut down the measurement apparatus 10 after setting the timer activation time to the timer 12. The measurement apparatus 10 shuts down and transitions to the sleep state. The timer 12 operates even when the measurement apparatus 10 is in the sleep state. Upon reaching the set timer activation time, the timer 12 outputs the activation signal to the activation processing unit 13. Upon an input of the activation signal, the activation processing unit 13 starts to activate the measurement apparatus 10 and warms up the attached module.

The warm-up of the attached module is completed when the warm-up time for the attached module has elapsed. The management unit 11 may notify the user by displaying that the warm-up of the attached module is completed. Upon reaching the use start time, the user may assume that the warm-up of the attached module is completed and start to use the measurement apparatus 10.

### <Example of Procedure of Method of Activating Measurement Apparatus 10>

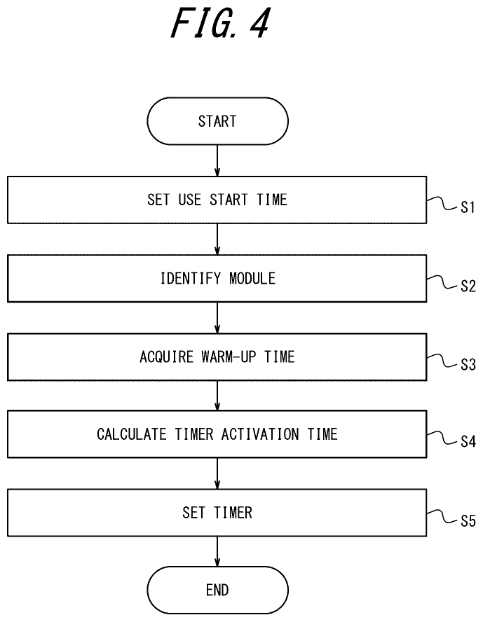

The measurement apparatus 10 may execute a method of activating the measurement apparatus 10, including a procedure of the flowchart illustrated in FIG. 4. The procedure illustrated in FIG. 4 is a procedure for setting the timer activation time to the timer 12 when the measurement apparatus 10 is in the activated state. The method of activating the measurement apparatus 10 may be realized as an activation program of the measurement apparatus 10 to be executed by the processor constituting the management unit 11 of the measurement apparatus 10. The activation program of the measurement apparatus 10 may be stored in a non-transitory computer readable medium.

The management unit 11 of the measurement apparatus 10 sets a use start time (step S1). For example, the management unit 11 may accept an input of the use start time from the user.

The management unit 11 identifies an attached module (step S2). The management unit 11 acquires a warm-up time for the identified attached module (step S3). Specifically, the management unit 11 may acquire the warm-up time associated with the identified attached module. When multiple modules are attached to the measurement apparatus 10, the management unit 11 identifies each attached module and acquires a warm-up time for each attached module.

The management unit 11 may just acquire the warm-up time for the attached module without identifying the attached module. In other words, the management unit 11 may not perform the process of step S2.

The management unit 11 calculates a timer activation time based on the use start time and the warm-up time for the attached module (step S4). Specifically, the management unit 11 calculates, as the timer activation time, a time at which at least the warm-up time for the attached module is subtracted from the use start time. When the multiple modules are attached to the measurement apparatus 10, the management unit 11 determines the longest warm-up time, among the warm-up times for the multiple attached modules, and calculates, as the timer activation time, a time at which at least the longest warm-up time is subtracted from the use start time.

The management unit 11 sets the calculated timer activation time to the timer 12 (step S5). After performing the process of step S5, the management unit 11 terminates execution of the procedure in the flowchart in FIG. 4.

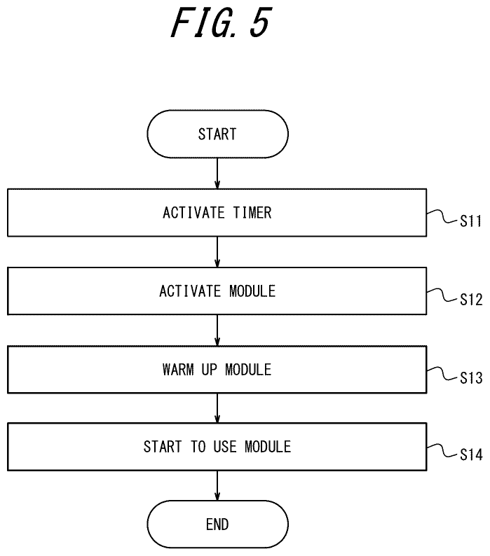

Assuming that the measurement apparatus 10 is shut down and in the sleep state after the timer activation time has been set to the timer 12. The measurement apparatus 10 may further execute the method of activating the measurement apparatus 10, including a procedure of the flowchart illustrated in FIG. 5. The procedure illustrated in FIG. 5 is a procedure for timer activation when the timer activation time has been set to the timer 12.

The timer 12 of the measurement apparatus 10 continues operating while the measurement apparatus 10 is in the sleep state, and activates upon reaching the timer activation time (step S11). Specifically, upon reaching the timer activation time, the timer 12 outputs an activation signal to the activation processing unit 13.

Upon an input of the activation signal, the activation processing unit 13 of the measurement apparatus 10 activates the activation processing unit 13 itself, and activates the attached module after the measurement apparatus 10 returns to the activated state from the sleep state (step S12). The attached module performs a warm-up (step S13). In this case, the measurement apparatus 10 transitions to the warm-up state.

After the warm-up time has elapsed, the attached module completes the warm-up and starts to be used (step S14). In this case, the measurement apparatus 10 transitions to the usable state. The user starts measurement using the measurement apparatus 10 that has been put into the usable state. After performing the process of step S14, the measurement apparatus 10 completes execution of the procedure in the flowchart in FIG. 5.

### <Conclusion>

As described above, the measurement apparatus 10 according to the present disclosure automatically starts to be activated using the timer 12. In other words, the measurement apparatus 10 starts to be activated without the user having to touch the measurement apparatus 10 and input the activation operation. On the other hand, as the comparative example, a case in which the user comes to the installation location of the measurement apparatus 10, inputs the activation operation to the measurement apparatus 10, and waits until the warm-up is completed is conceivable. The comparative example causes a long waiting time for the user at the installation location of the measurement apparatus 10. However, in the measurement apparatus 10 according to the present disclosure, the measurement apparatus 10 automatically starts to be activated, so that the user does not have to come to the installation location of the measurement apparatus 10 for at least part of the period from when the measurement apparatus 10 starts to be activated until when the measurement apparatus 10 is put into the usable state. The user may come to the installation location of the measurement apparatus 10 at a time when the measurement apparatus 10 is assumed to be definitely put into the usable state. As a result, the user can make effective use of time. In addition, the user's convenience is improved.

The measurement apparatus 10 according to the present disclosure can calculate the timer activation time based on the use start time set by the user and the warm-up time for the attached module, and can set the timer activation time to the timer 12. By setting the timer activation time based on the warm-up time, the measurement apparatus 10 can start to be activated according to the time at which the user desires to start to use the measurement apparatus 10. As a result, the waiting time for the user is reduced. In addition, the time from when the measurement apparatus 10 is put into the usable state until when the user starts to use the measurement apparatus 10 is reduced. In other words, the time that the measurement apparatus 10 is not used by the user, even though the measurement apparatus 10 is in the usable state, is reduced. As a result, the power consumption of the measurement apparatus 10 is reduced.

The measurement apparatus 10 can identify the attached module and acquire the warm-up time for the identified attached module. In other words, the user does not have to know the warm-up time for the attached module. As a result, the user's convenience is improved.

The measurement apparatus 10 according to the present disclosure can set the timer activation time based on the longest warm-up time, among the warm-up times for the multiple attached modules, even when the multiple modules are attached to the measurement apparatus 10, and start to activate the multiple attached modules. Therefore, the user does not have to know the warm-up time for each of the multiple attached modules. As a result, the user's convenience is improved. In addition, the time from when the measurement apparatus 10 is put into the usable state until when the user starts to use the measurement apparatus 10 is reduced. In other words, the time that the measurement apparatus 10 is not used by the user, even though the measurement apparatus 10 is in the usable state, is reduced. As a result, the power consumption of the measurement apparatus 10 is reduced.

### Other Embodiments

Other embodiments of the measurement apparatus 10 will be described.

### <Activation of External Apparatus>

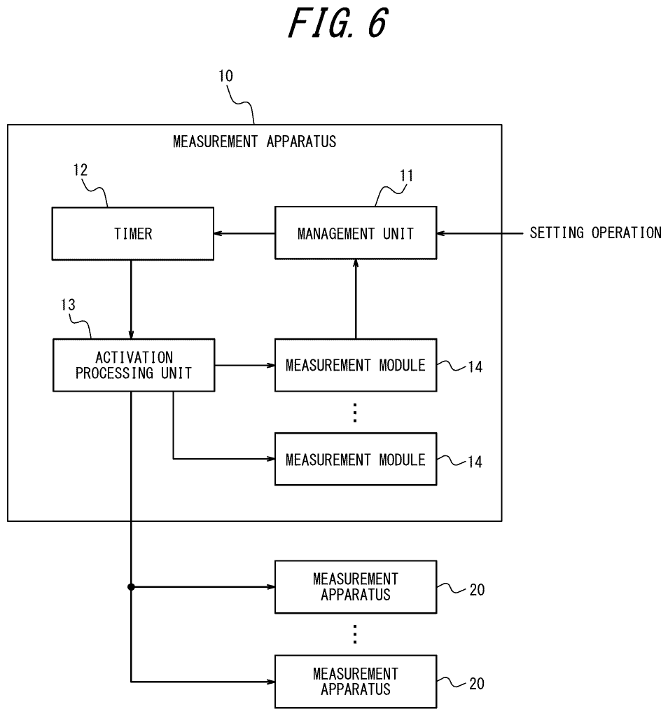

The measurement apparatus 10 may activate an external apparatus from the activation processing unit 13 by timer activation. As illustrated in FIG. 6, the measurement apparatus 10 according to another embodiment may be configured so that, in addition to the configuration illustrated in FIG. 2, the activation processing unit 13 can output a signal to activate one or more external measurement apparatuses 20. In other words, the activation processing unit 13 may be provided with a terminal that can be connected to the external apparatus and output, from the terminal, the signal to activate the external apparatus upon the input of the activation signal from the timer 12. The external measurement apparatus 20 may be configured in the same manner as the measurement apparatus 10, and may start to be activated when the signal is input to the same configuration as the activation processing unit 13 of the measurement apparatus 10.

The signal by which the activation processing unit 13 activates the external measurement apparatus 20 may be output using Wake-on-LAN. The activation processing unit 13 may output the activation signal output by the timer 12 to the external measurement apparatus 20. In this case, the external measurement apparatus 20 is configured to be able to start to be activated upon an input of the activation signal from the activation processing unit 13. The activation processing unit 13 is not limited to these examples and may output some signal to activate the external measurement apparatus 20. The external measurement apparatus 20 is configured to be able to start to be activated upon an input of some signal from the activation processing unit 13.

Since the activation processing unit 13 of the measurement apparatus 10 can activate the external measurement apparatus 20, the user can use the external measurement apparatus 20 in the same manner as if the external measurement apparatus 20 were provided with a timer 12, even when the external measurement apparatus 20 is not provided with a timer 12. As a result, the user's convenience is improved.

### <Calculation of Warm-Up Time>

The warm-up time for the module is not always constant. The warm-up time for the module may vary depending on, for example, the environment in which the module is installed.

The environment in which the module is installed is also referred to as an installation environment. The management unit 11 may calculate the warm-up time for the module based on the installation environment. The installation environment may include information on the outside temperature, humidity, or the like of the location in which the measurement apparatus 10 is installed. The module installation environment is not limited to these examples and may include information that affects the duration of the warm-up time for the module. The measurement apparatus 10 may be further provided with sensors that acquire various information on the outside temperature, humidity, and the like included in the installation environment.

For example, the management unit 11 may calculate the warm-up time for the module for which the warm-up is performed, based on the outside temperature of the location in which the module is installed, so that the temperature of the module becomes suitable for measurement. In this case, the management unit 11 may acquire the warm-up time for the module as a mathematical expression that enables to calculate the warm-up time as a function of the outside temperature, instead of acquiring the warm-up time of the module as a predetermined value. The management unit 11 may also acquire the warm-up time for the module, as a table representing the relationship between the outside temperature and the warm-up time.

The management unit 11 may calculate the warm-up time for the module based on a track record of past warm-up times for the module. For example, the management unit 11 may calculate the average of the past warm-up times as the warm-up time for the module. The management unit 11 may calculate, as the warm-up time for the module, the average of the warm-up times in the most recently executed predetermined number of warm-ups.

The management unit 11 may calculate the warm-up time according to the use start time of the measurement apparatus 10, based on trends in variation of the warm-up time according to time of day within a day. The management unit 11 may calculate the warm-up time according to a day of use of the measurement apparatus 10, based on trends in variation of the warm-up time according to seasonal variations within a year.

As described above, the management unit 11 can calculate the warm-up time based on the installation environment or the past track record, even when the warm-up time for the module is not constant. Since the variable warm-up time can be calculated, the user does not have to know trends in variation of the warm-up time for the attached module or to predict the warm-up time. As a result, the user's convenience is improved.

### <Scheduling Function of Timer 12>

The timer 12 may be configured to allow the single timer activation time to be set. In this case, the measurement apparatus 10 automatically starts to be activated only once upon reaching the set timer activation time. The user may set the timer activation time or the use start time whenever the user finishes using the measurement apparatus 10. The timer 12 may be configured to allow multiple timer activation times to be set. By allowing the multiple timer activation times to be set to the timer 12, an omission of setting the timer activation times or the use start time is reduced. As a result, the user's convenience is improved.

The timer 12 may be configured to allow a time determined by a

predetermined schedule to be set as the timer activation time. The predetermined schedule may be a schedule based on a predetermined cycle. For example, the management unit 11 may set, to the timer 12, the timer activation time to put the measurement apparatus 10 into the usable state at a fixed time each day. For example, the measurement unit 11 may set, to the timer 12, the timer activation time to put the measurement apparatus 10 into the usable state at a fixed time on a fixed day of the week. Since the time determined by the predetermined schedule can be set to the timer 12, as the timer activation time, an omission of setting the timer activation time or the use start time is reduced. This also eliminates the need for the user's operation to set the timer activation time or the use start time. As a result, the user's convenience is improved.

### <Individual Activation of Modules>

When multiple modules are attached, the measurement apparatus 10 may be configured to be able to activate the individual attached modules at different times. For example, the activation processing unit 13 may be configured to be able to activate only one attached module or only some attached modules, among the multiple attached modules. In this case, the timer 12 outputs the activation signal corresponding to the attached module to be activated. The timer 12 may be configured to allow the timer activation time corresponding to each of multiple activation targets to be set.

The measurement apparatus 10 may have one activation processing unit 13 for each attached module. The measurement apparatus 10 may divide the attached modules into groups of attached modules to be activated simultaneously. The measurement apparatus 10 may be provided with one activation processing unit 13 for each group to be activated simultaneously. In other words, the measurement apparatus 10 may be provided with multiple activation processing units 13. The timer 12 may output the activation signal to each of the multiple activation processing units 13 at different times. The timer 12 may be configured to allow the timer activation time for each of the multiple activation processing units 13 to be set.

Since only some of the attached modules can be automatically activated,

unnecessary modules are not activated. Not activating the unnecessary modules reduces the power consumption of the measurement apparatus 10.

Although the embodiments according to the present disclosure have been described based on the drawings and examples, it should be noted that one skilled in the art can make various variations or modifications based on the present disclosure. Accordingly, it should be noted that these variations or modifications are included in the scope of the present disclosure. For example, the functions included in each component can be rearranged so as not to be logically inconsistent, and multiple components can be combined into one or divided.

1. A measurement apparatus comprising:
a management unit;
a timer;
an activation processing unit; and
a module,
wherein
the management unit is configured to set a timer activation time to the timer,
the timer is configured to output an activation signal to the activation processing unit upon reaching the timer activation time, and
the activation processing unit is configured to start to activate the module upon an input of the activation signal.

2. The measurement apparatus according to claim 1, wherein the management unit is configured to:
acquire a use start time at which a user starts to use the measurement apparatus, and a warm-up time for an attached module that is the module detachably attached to the measurement apparatus; and
set, to the timer, a time at which at least the warm-up time is subtracted from the use start time, as the timer activation time.

3. The measurement apparatus according to claim 2, wherein in a case in which a plurality of modules is attached as attached modules, the management unit sets, to the timer, a time at which at least a longest warm-up time, among warm-up times for the plurality of respective attached modules, is subtracted from the use start time, as the timer activation time.

4. The measurement apparatus according to claim 3, wherein the activation processing unit is configured to start to activate only some of the plurality of attached modules.

5. The measurement apparatus according to claim 2, wherein the management unit is configured to calculate the warm-up time for the attached module based on an installation environment of the measurement apparatus.

6. The measurement apparatus according to claim 2, wherein the management unit is configured to calculate the warm-up time for the attached module based on a track record of a past warm-up time for the attached module.

7. The measurement apparatus according to claim 1, wherein the management unit is configured to set, to the timer, a time determined from a predetermined schedule, as the timer activation time.

8. The measurement apparatus according to claim 1, wherein the activation processing unit is configured to:
comprise a terminal connectable to an external apparatus, and
output, from the terminal, a signal to activate the external apparatus upon the input of the activation signal.

9. A method of activating a measurement apparatus including a management unit, a timer, an activation processing unit, and a module, the method comprising:
setting, by the management unit, a timer activation time to the timer;
outputting, by the timer, an activation signal upon reaching the timer activation time; and
starting, by the activation processing unit, to activate the module upon an input of the activation signal.

10. A non-transitory computer readable medium storing an activation program for a measurement apparatus including a module, a management unit, a timer configured to output an activation signal upon reaching a timer activation time, and an activation processing unit configured to start to activate the module upon an input of the activation signal, the activation program for the measurement apparatus configured to cause the measurement apparatus to execute an operation, the operation comprising:
setting, by the management unit, the timer activation time to the timer.
